(19) United States
(12) Patent Application Publication
(10) Pub. No.: US 2025/0024545 A1
(43) Pub. Date: Jan. 16, 2025

(54) USER EQUIPMENT CONTEXT FETCH FOR SMALL DATA TRANSMISSION

(71) Applicant: HUAWEI TECHNOLOGIES CO., LTD., Shenzhen (CN)

(72) Inventors: Jagdeep Singh Ahluwalia, Berkshire (GB); Yinghao Guo, Shanghai (CN); Dawid Koziol, Berkshire (GB); Chunhua You, Shanghai (CN); Mengchen Zhang, Beijing (CN); Haibo Xu, Beijing (CN)

(21) Appl. No.: 18/903,811

(22) Filed: Oct. 1, 2024

Related U.S. Application Data
(63) Continuation of application No. PCT/CN2022/084846, filed on Apr. 1, 2022.

(51) Int. Cl. H04W 76/20; H04W 36/00; H04W 76/30

(52) U.S. Cl. CPC H04W 76/20; H04W 36/0033; H04W 76/30

(57) ABSTRACT

Described is a network device (203) configured to operate as a first node in a communications network (200) for a user device (201) initiating a small data transmission communication session through a target node (202) in the communications network (200), the network device (203) being configured to, upon receiving a request from the target node (202), send a message to the target node (202), the message comprising an indication of small data transmission configuration information (401, 506) for the user device (201). A corresponding network device (202) configured to operate as a target node is also described.

### CROSS-REFERENCE TO RELATED APPLICATIONS

This application is a continuation of International Application No. PCT/CN2022/084846, filed on Apr. 1, 2022, the disclosure of which is hereby incorporated by reference in its entirety.

### FIELD OF THE INVENTION

This disclosure relates to data transmission in a communications network, in particular to a small data transmission (SDT) procedure in such a network.

### BACKGROUND

A communications network generally comprises multiple nodes. Each node is a connection point in the communications network and can act as an endpoint for data transmission or redistribution. Each node may be, for example, a gNodeB (gNB).

When a user equipment device (UE), such as a mobile phone, in the communications network is configured with SDT, the SDT-related context information for the UE is stored in the anchor node for the communication session.

However, the UE can initiate the SDT procedure in a different node (i.e. in a node which is different to the node in which the context information for the UE, referred to herein as the UE Context, including SDT-related context information, is available).

### SUMMARY OF THE INVENTION

According to one aspect, there is provided a network device configured to operate as a first node in a communications network for a user device initiating a small data transmission communication session through a target node in the communications network, the network device being configured to, upon receiving a request from the target node, send a message to the target node, the message comprising an indication of small data transmission configuration information for the user device.

According to another aspect, there is provided a network device configured to operate as a first node in a communications network for a user device transitioning from the first node to a target node in the communications network during a small data transmission communication session, the network device being configured to, upon receiving a request from the target node, send a message to the target node comprising an indication of small data transmission configuration information for the user device.

Based on the small data transmission configuration information for the user device that is sent to the target node, the target node can establish the user device context to successfully perform small data transmission-related procedures.

The following features may apply to any embodiment of the present application, where the first node operates as either a first node for a user device initiating a small data transmission communication session through a target node, or as a first node for a user device transitioning from the first node to a target node in the communications network during a small data transmission communication session.

The first node may be a source node in the communications network. The first node may be a previous/last serving node to the target node that maintains small data transmission configuration information for the user device in the communications network. The target node may have no prior knowledge of the small data transmission configuration information for the user device. The target node may operate as a receiving node. Upon transfer of the small data configuration information to the target node, the target node may operate as a new serving node for the user device in the SDT session. The SDT configuration information for the user device may therefore be transferred from the last serving node when it makes a decision to relocate the UE Context (including the SDT configuration information for the UE), or to anchor (i.e not relocate the UE Context) an SDT session when the SDT session is initiated in a non-anchor node, or when the user device performs cell reselection during the SDT session and moves away from the serving node. This may assist in the initiation or transfer of the SDT session. The SDT configuration information for the user device may, once received, be stored at the target node.

The network device may be configured to transmit the message as a radio resource control (RRC) message. For example, the network device may be configured to generate an inter-node (from the first node to the target node) radio resource control message that includes an RRC Context information element (IE) transmitted as part of a small data transmission procedure. The message may therefore comprise context information for the user device. This may provide compatibility with existing architectures and cater for future extensions.

The radio resource control message may comprise an Access Stratum Configuration (AS-Config) field and an Access Stratum Context (AS-Context) field. The network device may be configured to include the indication of small data transmission configuration information for the user device in the AS-Config field. The network device may be configured to include the indication of small data transmission configuration information for the user device in the AS-Context field. This may provide compatibility with existing architectures and cater for future extensions.

The message may comprise an earlier RRCRelease message that was sent to the user device when configuring small data transmission to and from the first node. The earlier RRC message may comprise contents which are not ciphered or integrity protected. This may be an efficient way of sending the SDT configuration information.

The request from the target node may be part of an XnAP Retrieve UE Context procedure. The indication of small data transmission configuration information for the user device may be contained within a UE Context Information field in an XnAP Retrieve UE Context response message.

The network device may be a base station. The network device may be a gNodeB. This may allow the network device to be used in a telecommunications network.

A user device may be either in RRC_CONNECTED state or in RRC_INACTIVE state when an RRC connection has been established. If this is not the case, i.e. no RRC connection is established, the UE is in RRC_IDLE state. In the RRC_INACTIVE state, a UE in a network, such as a Next Generation Radio Access Network (NG-RAN), can move within an area configured by the NG-RAN (the RAN-based notification area, RNA) without notifying the NG-RAN. In the RRC_INACTIVE state, the last serving node (the first node above) keeps the UE context information and the UE-associated NG connection with the serving Access and Mobility Management Function and User Plane Function.

Upon sending the message to the target node, the user device may be able to transmit or receive small data to or from the target node while remaining in RRC INACTIVE Mode.

According to a further aspect, there is provided a method for implementation at a network device configured to operate as a first node in a communications network for a user device initiating a small data transmission communication session through a target node in the communications network, the method comprising, upon receiving a request from the target node, sending a message to the target node, the message comprising an indication of small data transmission configuration information for the user device.

According to another aspect, there is provided a method for implementation at a network device configured to operate as a first node in a communications network for a user device transitioning from the first node to a target node in the communications network during a small data transmission communication session, the method comprising, upon receiving a request from the target node, sending a message to the target node, the message comprising an indication of small data transmission configuration information for the user device.

Based on the small data transmission configuration information for the user device sent to the target node, the method may allow the target node to establish the user device context to successfully perform small data transmission-related procedures.

According to another aspect, there is provided a network device configured to operate as a target node in a communications network for a user device initiating a small data transmission communication session through the target node, the network device being configured to receive a request from the user device for the network device to operate as the target node for the small data transmission communication session, send a request to a first node in the communications network for context information for the user device, and receive a message from the first node comprising the context information for the user device, the context information comprising an indication of small data transmission configuration information for the user device.

According to a further aspect, there is provided a network device configured to operate as a target node in a communications network for a user device transitioning from a first node in the communications network to the target node during a small data transmission communication session, the network device being configured to receive a request from the user device for the network device to operate as the target node for the small data transmission communication session, send a request to the first node for context information for the user device, and receive a message from the first node comprising the context information for the user device, the context information comprising an indication of small data transmission configuration information for the user device.

Based on the received small data transmission configuration information for the user device, the target node can establish the user device context to successfully perform small data transmission-related procedures.

The following features may apply to any embodiment of the present application, where the target node operates as either a target node for a user device initiating a small data transmission communication session through the target node, or as a target node for a user device transitioning from a first node in the communications network to the target node during a small data transmission communication session.

The network device may be configured to operate as a new serving node for the user device after relocating the context information for the user device from the first node to the network device. The first node may be a source node in the communications network. The first node may be a previous/last serving node to the target node that maintains small data transmission configuration information for the user device in the communications network. The target node may have no prior knowledge of the small data transmission configuration information for the user device. The target node may operate as a receiving node. Upon transfer of the small data configuration information to the target node, the target node may operate as a new serving node for the user device in the SDT session. The SDT configuration information for the user device may therefore be transferred from the last serving node when it makes a decision to relocate the UE context (including the SDT configuration information for the UE), or to anchor (i.e not relocate the UE Context) an SDT session when the SDT session is initiated in a non-anchor node, or when the user device performs cell reselection during the SDT session and moves away from the serving node. This may assist in the initiation or transfer of the SDT session. The SDT configuration information for the user device may, once received, be stored at the target node.

The message (sent between the first node and the target node) may be a radio resource control (RRC) message. For example, the message may include an RRC Context information element (IE) transmitted as part of a small data transmission procedure. This may provide compatibility with existing architectures.

The radio resource control message may comprise an AS-Config field and an AS-Context field. The indication of small data transmission configuration information for the user device may be included in the AS-Config field. The indication of small data transmission configuration information for the user device may be included in the AS-Context field. This may provide compatibility with existing architectures.

The message may comprise an earlier RRCRelease message that was sent to the user device when configuring small data transmission to and from the first node. The earlier RRCRelease message may comprise contents which are not ciphered or integrity protected. This may be an efficient way of sending the SDT configuration information.

The indication of small data transmission configuration information for the user device may be contained within a UE Context Information field in an XnAP Retrieve UE Context response message. This may allow for compatibility with existing processes.

The network device may be a base station. The network device may be a gNodeB. This may allow the network device to be used in a telecommunications network.

Upon sending the message to the target node, the user device may be able to transmit or receive small data to or from the target node while remaining in RRC INACTIVE Mode.

According to a further aspect, there is provided a method for implementation at a network device configured to operate as a target node in a communications network for a user device initiating a small data transmission communication session through the target node, the method comprising receiving a request from the user device for the network device to operate as the target node for the small data transmission communication session, sending a request to a first node in the communications network for context information for the user device, and receiving a message from the first node comprising the context information for the user device, the context information comprising an indication of small data transmission configuration information for the user device.

According to a further aspect, there is provided a method for implementation at a network device configured to operate as a target node in a communications network for a user device transitioning from a first node in the communications network to the target node during a small data transmission communication session, the method comprising receiving a request from the user device for the network device to operate as the target node for the small data transmission communication session, sending a request to the first node for context information for the user device, and receiving a message from the first node comprising the context information for the user device, the context information comprising an indication of small data transmission configuration information for the user device.

Based on the received small data transmission configuration information for the user device, the method above may allow the target node to establish the user device context to successfully perform small data transmission-related procedures.

According to a further aspect, there is provided a computer-readable storage medium having stored thereon computer-readable instructions that, when executed at a computer system, cause the computer system to perform the method set out above. The computer system may comprise one or more processors. The computer-readable storage medium may be a non-transitory computer-readable storage medium.

### BRIEF DESCRIPTION OF THE FIGURES

The present disclosure will now be described by way of example with reference to the accompanying drawings. In the drawings:

FIGS. 1 (a) and 1 (b) schematically illustrate components in a Next Generation Radio Access Network (NG-RAN).

FIG. 2 shows an exemplary communication flow between the devices in a network.

FIG. 3 shows an example of a RETRIEVE UE CONTEXT RESPONSE message.

FIG. 4 shows an example of the details of the SDT configuration information within an RRCRelease message.

FIG. 5 shows an example where the SDT configuration information for the UE is contained within the RRC Container in the RRC Context IE in the XnAP: RETRIEVE UE CONTEXT RESPONSE message.

FIG. 6 shows an example where the SDT-related UE specific information is included as part of the AS-Config field.

FIG. 7 shows an example where the SDT-related UE specific information is included as part of the AS-Context field.

FIG. 8 shows an example where the SDT-related UE specific information is included in the RRCRelease message in the AS-Config field within the RRC Context IE.

FIG. 9 shows an example where the SDT-related UE specific information is directly included as a part of the UE Context Information IE in the XnAP: RETRIEVE UE CONTEXT RESPONSE message.

FIG. 10 shows a flow chart of the steps of an example of a method for implementation at a network device configured to operate as a target node in a communications network for a user device initiating a small data transmission communication session through the target node.

### DETAILED DESCRIPTION OF THE INVENTION

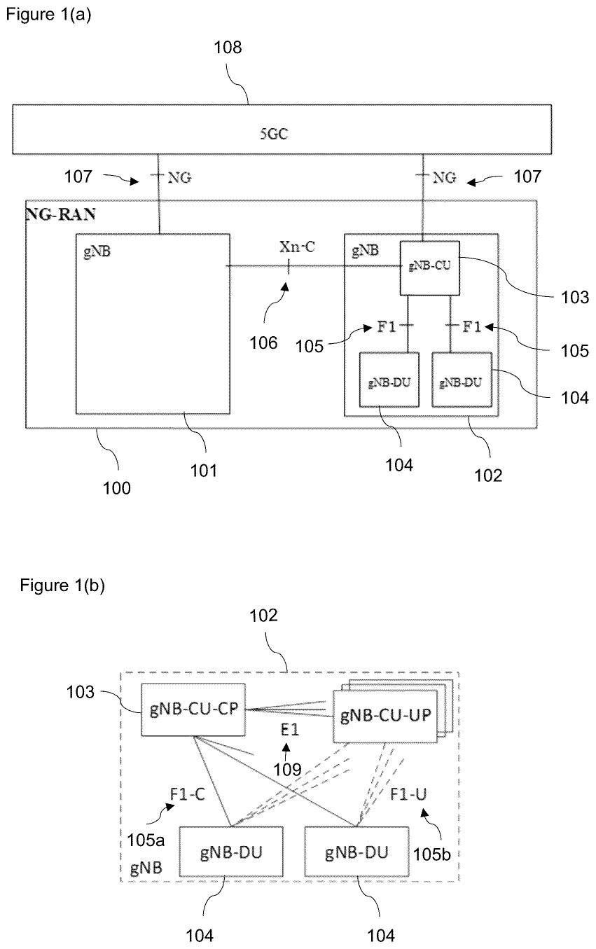

As schematically illustrated in FIG. 1 (a), a Next Generation Radio Access Network (NG-RAN) 100 may comprise multiple nodes. In this example, the network 100 comprises gNodeBs (gNBs) 101, 102. Each gNB 101, 102 may comprise multiple computing entities, such as a Centralised Unit (CU) 103 and multiple Distributed Units (DU) 104. The CU may communicate with a DU via an F1 interface 105, which is an interface that connects a gNB CU to a gNB DU.

The two gNBs 101, 102 may be interconnected with each other by means of an Xn network interface 106, which is a network interface between the NG-RAN nodes 101, 102 of the NG-RAN 100. In this example, the Xn interface 106 is an Xn-Control plane interface (Xn-C). The gNBs are also connected by means of Next Generation (NG) network interfaces 107 to the 5G Core Network (5GC) 108, more specifically to the Access and Mobility Management Function (AMF) by means of a control plane interface (NG-C) between the NG-RAN 100 and the 5GC 108 and to the User Plane Function (UPF) by means of a user plane interface (NG-U) between the NG-RAN 100 and the 5GC 108.

Each node may comprise at least one processor and at least one memory. The memory stores in a non-transient way code that is executable by the processor(s) to implement the node in the manner described herein. The nodes may also comprise a transceiver for transmitting and receiving data. The communications network is preferably a wireless network.

SDT aims at creating a solution where a UE is able to transmit or receive small data to or from a network node while remaining in RRC INACTIVE Mode.

The solutions described herein detail the information that may be transferred as part of the SDT-related UE context and how the information may be transferred between nodes.

In embodiments of the present application, the SDT configuration information may be transferred between a first node (for example, a source node, an anchor node or a last serving node) and a target node (which can act as a receiving or new serving node) when a user device initiates a new small data transmission communication session through a target node in the communications network, or when a user device transitions from the first node to a target node in the communications network during a small data transmission communication session.

Source and target nodes are typically used for handover procedures, or for cell reselection procedures while continuing an SDT session across the nodes of the network.

The last serving node is the node in the network where the UE context information (including the SDT configuration information) is present and the node with which the UE had its last SDT session. The receiving node is a node in the network other than the last serving node, through which the UE initiates an SDT session. The receiving node becomes the new serving node for the UE after the UE context information is relocated from the last serving node to the receiving node.

The UE Context may generally include information such as the Security Key, UE Radio Capability, UE Security Capabilities and configuration parameters for configuring the radio interface protocol layers.

The information may be transferred from the last serving gNB to the receiving gNB on an Xn interface. The information may then be transferred on the control plane of the F1 interface (F1-C (F1-U) and on the E1 (transmission) interface, as shown at 105a, 105b and 109 respectively in FIG. 1 (b).

When the UE is configured with SDT, the SDT-related UE context/configuration of the UE is stored in the last serving gNB, which may be an anchor gNB.

In a first example, a UE device in a communications network (which may be a NG-RAN, as shown in FIG. 1) initiates a new SDT session in a different node to the node in which the UE Context, including the SDT-related context/configuration information, is available. This node in which the UE context is available is referred to herein as the last (or previous) serving node. The last serving node may have previously served as an anchor node. The last serving node may be a source node in the communications network. However, as will be described in more detail later, the same techniques can be used when a device is transitioning between the last serving and receiving nodes during an ongoing (i.e. active) communication session.

The SDT-related UE context transfer should be performed from the last serving node to the new serving node (which may also be referred to as the receiving node or target node) during relocation. Without the transfer of SDT related configuration, the new serving node cannot continue with the SDT procedure. Based on the received SDT-related information for the UE, the receiving node can establish the UE context and can continue with the SDT procedure.

For random-access channel (RACH) based SDT, the UE in the RRC_INACTIVE mode can initiate RACH and request RRC resume, together with uplink SDT data/signaling.

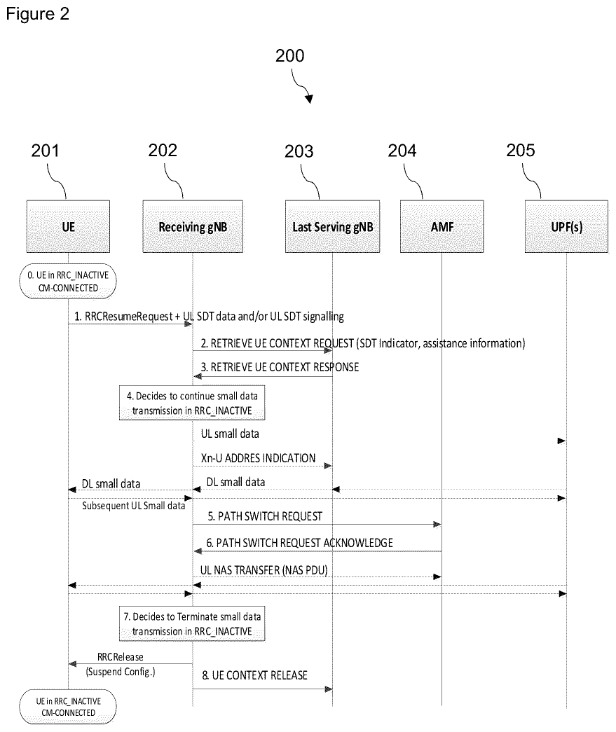

An example will now be described with reference to FIG. 2, which illustrates an overall procedure for RACH-based SDT procedure with UE context relocation.

The procedures are also applicable for Mobile Terminated SDT procedures.

To illustrate this aspect, FIG. 2 shows an exemplary communication flow between the devices in a network 200. The devices in the network include a UE 201, gNBs 202 and 203, AMF 204 and UPF 205. The gNBs 202, 203 may be base stations or other network devices.

gNB 202 is the new serving/receiving/target node and gNB 203 is the last serving node, which may be a source node or anchor node of the communication network.

At the start of the communication flow, the UE 201 is in RRC_INACTIVE mode. Then, an SDT procedure begins, for example because the UE 201 wants to transmit data to the gNB 202.

If the UE 201 accesses a gNB 202 other than the last serving gNB 203, the uplink (UL) SDT data/signaling is buffered at the receiving gNB 202, and then the receiving gNB 202 can trigger the XnAP Retrieve UE Context procedure.

In step 1, the UE 201 sends an RRCResumeRequest, as well as UL SDT data and/or UL SDT signalling to the receiving gNB 202.

In step 2, the receiving gNB 202 identifies the last serving gNB 203, for example using the Inactive Radio Network Temporary Identifier (I-RNTI). The gNB 202 retrieves the UE context information from the gNB 203 by means of a Xn-AP Retrieve UE Context procedure. The receiving gNB 202 sends a RETRIEVE UE CONTEXT REQUEST message to the last serving gNB 203. The receiving gNB 202 indicates that the UE request is for an SDT transaction and may also provide SDT assistance information (i.e., single packet, multiple packets).

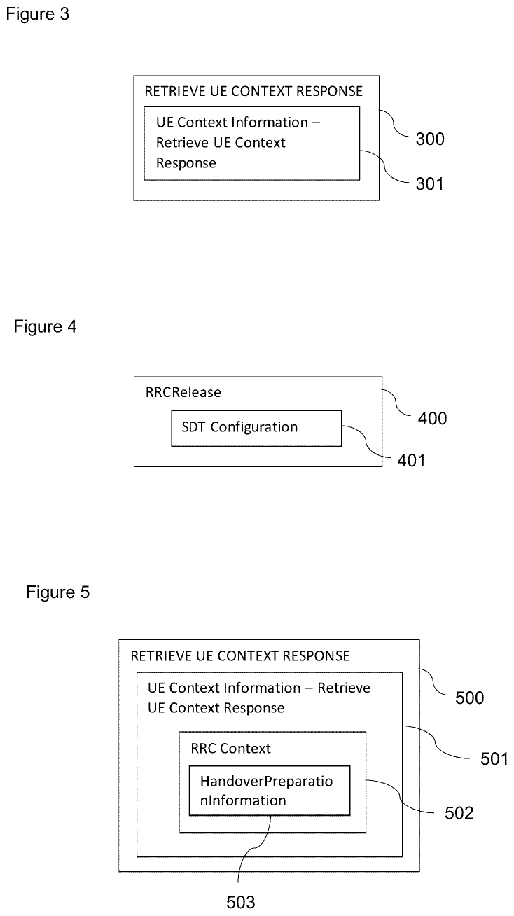

In step 3, the last serving gNB 203 decides to relocate the UE context for SDT to the gNB 202 and responds with the RETRIEVE UE CONTEXT RESPONSE message, as indicated at 300 in FIG. 3. The UE context may be transferred between the gNBs 203 and 202 within the UE Context Information Element (IE) 301 of the RETRIEVE UE CONTEXT RESPONSE message 300. The UL SDT data, if any, is delivered, to the UPF 205.

In steps 4-6, the receiving gNB 202 decides to keep the UE 201 in the RRC INACTIVE state for SDT. If loss of downlink (DL) user data buffered in the last serving gNB 203 shall be prevented, the receiving gNB 202 can provide forwarding addresses. The receiving gNB 202 can also initiate a NG-AP Path Switch procedure to establish a NG UE associated signalling connection to the serving AMF 204. After path switch, the UL NAS PDU is delivered to the AMF 204.

In step 7, after the SDT transmission is completed, the receiving gNB 202 generates and sends an RRCRelease message. The RRCRelease message is a message used by the network to initiate the RRC connection release procedure to transit a UE in the RRC_CONNECTED state to RRC_IDLE, or to transit a UE in RRC_CONNECTED to RRC_INACTIVE state. In this example, at step 7, the receiving gNB 202 generates and sends an RRCRelease message including the suspend indication to the UE 201 to send the UE back to RRC_INACTIVE.

In case DL non-SDT data or DL non-SDT signalling arrives, the receiving gNB 202 may decide to directly send the UE 201 to the RRC_CONNECTED state by sending an RRCResume message.

At step 8, the receiving gNB 202 can indicate the last serving gNB 203 to remove the UE context by sending the XnAP UE CONTEXT RELEASE message. The XnAP UE CONTEXT RELEASE message can be sent after step 6.

At the end of the session, the gNB 202 sends an RRCRelease message to the UE 201. The SDT procedure ends and the UE 201 enters RRC_INACTIVE mode.

In embodiments of the present application, there are multiple ways in which the SDT configuration information can be transferred from the last serving gNB to the receiving/new serving gNB (the target node). Some possible ways in which the SDT configuration information can be transferred from the last serving gNB to the receiving/new serving gNB (the target node) will now be described. The signaling may be performed on the Xn interface and in accordance with the procedure outlined with reference to FIG. 2.

The SDT related configuration information can be configured for the UE by means of an RRCRelease message, as schematically illustrated in FIG. 4. The SDT-related configuration information is indicated at 401.

Similar SDT configuration information can also be stored in the UE context within the last serving node and transferred to the new serving node when relocation is performed.

In some possible implementations, as schematically illustrated in FIG. 5, the SDT configuration information for the user device can be contained within an Xn Application Protocol (XnAP) RETRIEVE UE CONTEXT RESPONSE message 500. As discussed above, this is a message sent between nodes via the Xn interface to transfer the UE context information from the first node to the target node (for example, from node 203 to node 202 at step 3 in FIG. 2).

In this example, the RETRIEVE UE CONTEXT RESPONSE message includes a UE Context Information Element (IE) 501, which comprises an RRC Context IE 502. The SDT configuration information can be contained within an RRC Container in the RRC Context IE 502. In this example, the RRC Context IE 502 includes a “HandoverPreparationInformation” IE 503, which in one implementation comprises Access Stratum Configuration (AS-Config) (including RRCReconfiguration), Radio Resource Monitoring (RRM) config and Access Stratum Context (AS-Context) fields.

The HandoverPreparationInformation IE can be used to transfer the New Radio (NR) Radio Resource Control (RRC) information used by the target node during handover preparation or for UE Context retrieval, for example in the case of resume or re-establishment, including UE capability information.

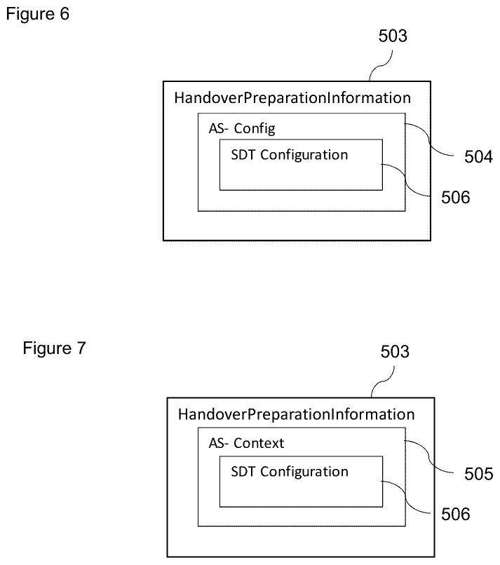

As schematically illustrated in FIGS. 6 and 7, the SDT-related UE specific configuration information 506 can be included either as the part of the AS-Config field 504 or the AS-Context field 505 of the HandoverPreparationInformation IE 503.

The last serving node may therefore be configured to include the indication of the SDT configuration information for the UE in the AS-Config field 504 or in the AS-Context field 505. This may provide compatibility with existing architectures.

Alternatively, as schematically illustrated in FIG. 8, the SDT-related UE specific information can be included in an RRCRelease message 507, which is not ciphered or integrity protected, in the AS-Config field 504 within the HandoverPreparationInformation IE 503 of the RRC Context IE 502 (for example a Transparent Container IE, used to pass information between the nodes).

The whole of the RRCRelease message (including SDT configuration information) that was sent to the UE when configuring SDT for the last serving node can be included in the RRCRelease message 507, or alternatively in a new message in the AS-Config field 504. Therefore, the message sent from the first node to the target node comprising the SDT-related configuration information for the UE may comprise an earlier RRCRelease message that was sent to the user device when configuring small data transmission to and from the last serving node.

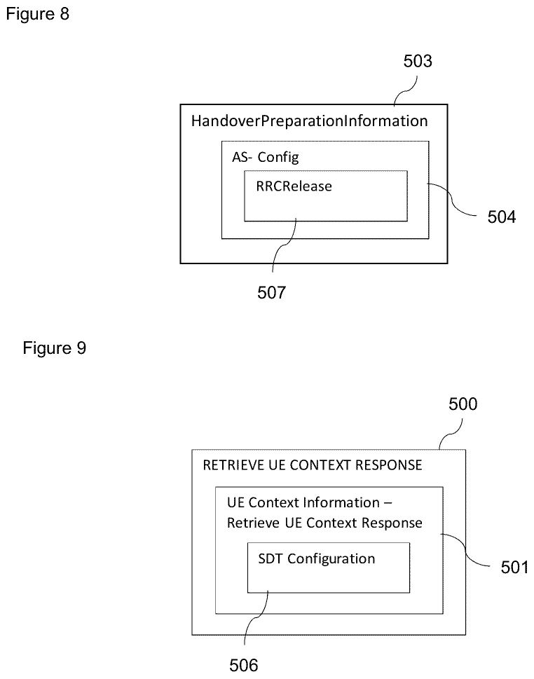

In other implementations, the SDT-related UE specific information 506 can be directly included as a part of the UE Context IE 501 in the XnAP: RETRIEVE UE CONTEXT RESPONSE message 500, as schematically illustrated in FIG. 9.

The request from the receiving/new serving node (for the UE context) may therefore be part of an XnAP Retrieve UE Context procedure and the indication of SDT configuration information for the UE may be contained within a UE Context Information field in an XnAP Retrieve UE Context response message.

The SDT-related configuration information may comprise one or more of the following fields or IEs: sdt-DRB-List-r17, sdt-SRB2-Indication-R17, and sdt-DRB-Continue-ROHC-R17, sdt-MAC-PHY-CG-Config-R17. The definition of these exemplary information fields will be given in the following.

Once the SDT-related UE context IEs have been received by the new serving node, the new serving node may be configured to store the information, which can be used as follows:

sdt-DRB-List-r17-based on this information, the new gNB-CU-CP can establish the UE context in the new gNB-CU-UP via the Bearer Context Setup procedure and indicate to the gNB-CU-UP which bearers are SDT bearers. gNB-CU-UP can accordingly keep the non-SDT bearers suspended and resume the SDT bearers after the UE context is set up. Additionally, the gNB CU can identify SDT RLC configuration and forward it to its DU in a UE CONTEXT SETUP REQUEST message and establish an F1-U tunnel for SDT bearers only, i.e gNB DU does not need to establish all RLC entities.

sdt-SRB2-Indication-R17—the new gNB CU should know if the UE has been configured with SRB 2 for SDT for similar reasons as for the SDT DRB as indicated above. Furthermore, based on this, the gNB can decide to transfer any DL Non-Access Stratum (NAS) signalling using SDT, or makes the transfer it needs to move the UE to the connected state when the DL NAS message arrives.

sdt-DRB-Continue-ROHC-R17—this can also be used by the gNB CU to know if the Robust Header Compression (ROHC) is to be continued within the RNA, or just in a cell where the SDT procedure is initiated.

sdt-MAC-PHY-CG-Config-R17—it is not essential that this information is transferred to the new serving gNB, as the new serving gNB may use its own configuration. However, if the UE is configured with Configured Grant (CG) SDT Configuration and this configuration is provided to the new gNB, then it could reuse this and provide a delta configuration (i.e not the full configuration) to UE in the next RRCRelease message. Therefore, this can be an optional IE to be transferred between the nodes.

The new serving gNB can decide to keep the same configuration received from the last serving gNB and use delta signaling for these IEs, or it can change the configuration in the next RRCRelease message (i.e. new serving gNB can perform delta signaling even after inter node UE Context transfer).

The main advantage of using delta signaling is that the CG configuration can be updated using delta signaling, hence it is desirable that the CG-configuration is also included during the context transfer.

Based on the transferred SDT configuration information for the UE, the new gNB may perform SDT-related procedures on the F1 and E1 interfaces.

In summary, in embodiments of the present application, a network device configured to operate as a first node (such as a source node, anchor node, or previous/last serving node) in a communications network for a user device initiating a small data transmission communication session through a target node (which can act as a receiving node or new serving node) in the communications network can perform a method comprising, upon receiving a request from the target node, sending a message to the target node, the message comprising an indication of small data transmission configuration information for the user device.

A similar method may also be performed at a network device configured to operate as a first node in a communications network for a user device which is transitioning from the first node to a target node during a small data transmission communication session. In this case, the method comprises, upon receiving a request from the target node, sending a message to the target node comprising an indication of small data transmission configuration information for the user device.

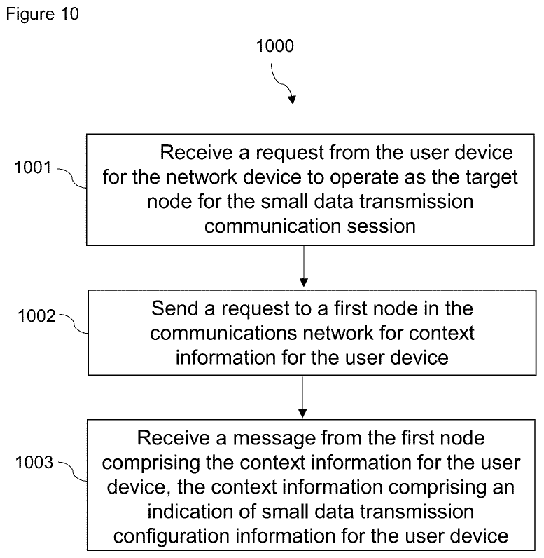

FIG. 10 shows a flowchart summarising an example of a method for implementation at a network device configured to operate as a target node in a communications network for a user device initiating a small data transmission communication session through the target node, in accordance with embodiments of the present application. At step 1001, the method comprises receiving a request from the user device for the network device to operate as the target node for the small data transmission communication session. At step 1002, the method comprises sending a request to a first node in the communications network for context information for the user device. At step 1003, the method comprises receiving a message from the first node comprising the context information for the user device, the context information comprising an indication of small data transmission configuration information for the user device.

A similar method may also be used for a user device which is transitioning from a first node to the target node during a small data transmission communication session. In this case, the method comprises receiving a request from the user device for the network device to operate as the target node for the small data transmission communication session; sending a request to the first node for context information for the user device; and receiving a message from the first node comprising the context information for the user device, the context information comprising an indication of small data transmission configuration information for the user device.

As mentioned above, the first node may be a source node in the communications network. The first node may be a previous (i.e. last) serving node to the target node that maintains small data transmission configuration information for the user device in the communications network. The target node may be a receiving/new serving node in the communications network.

The SDT configuration information for the UE may therefore be transferred from the last serving gNB when it makes a decision to relocate, or to anchor a SDT session when the SDT session is initiated in a non-anchor gNB, or when the UE performs cell reselection during the SDT session and moves away from the serving gNB.

Based on the received SDT-related information for the UE, the target node can establish the UE context to successfully initiate or continue with the SDT procedure.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present application may consist of any such individual feature or combination of features. In view of the foregoing description it will be evident to a person skilled in the art that various modifications may be made within the scope of the application.

What is claimed is:

1. A network node (203) configured to operate as a first node in a communications network (200) for a user device (201) initiating a small data transmission communication session through a receiving node (202) in the communications network (200), the network node (203) being configured to:
receive a request from the receiving node (202); and
send a message to the receiving node (202), the message comprising an indication of small data transmission configuration information (506) for the user device (201).

2. The network node (203) as claimed in claim 1, wherein the message is RETRIEVE UE CONTEXT RESPONSE message.

3. The network node (203) as claimed in claim 1, wherein the message comprises user equipment (UE) context information, and the UE context information comprises the indication of small data transmission configuration information (506) for the user device (201).

4. The network node (203) as claimed in claim 3, wherein the UE context information comprises an access stratum configuration (AS-Config) field (504) and an access stratum context (AS-Context) field (505), the AS-Config field (504) comprises the indication of small data transmission configuration information (506) for the user device (201).

5. The network node (203) as claimed in claim 1, wherein the first node (203) is a source node in the communications network (200).

6. The network node (203) as claimed in claim 1, wherein the first node (203) is a last serving node that maintains small data transmission configuration information for the user device (201) in the communications network (200).

7. The network node (203) as claimed in claim 1, wherein the request from the receiving node (202) is part of an XnAP Retrieve UE Context procedure.

8. A network node (202) configured to operate as a receiving node in a communications network (200) for a user device (201) initiating a small data transmission communication session through the target node, the network node (202) being configured to:
receive (1001) a request from the user device (201) for the network node (202) to operate as the receiving node for the small data transmission communication session;
send (1002) a request to a first node (203) in the communications network for context information for the user device (201); and
receive (1003) a message from the first node (203) comprising the context information for the user device (201), the context information comprising an indication of small data transmission configuration information (506) for the user device (201).

9. The network node (202) as claimed in claim 8, wherein the message is RETRIEVE UE CONTEXT RESPONSE message.

10. The network node (203) as claimed in claim 8, wherein the message comprises UE context information, and the UE context information comprises the indication of small data transmission configuration information (506) for the user device (201).

11. The network node (203) as claimed in claim 10, wherein the UE context information comprises an AS-Config field (504) and an AS-Context field (505), the AS-Config field (504) comprises the indication of small data transmission configuration information (506) for the user device (201).

12. The network node (202) as claimed in claim 8, wherein the network node (202) is configured to operate as a receiving node for the user device (201) after relocating the context information for the user device from the first node (203) to the network node (202).

13. A system, comprising a network node (203) and a network node (202), wherein the network node (203) is configured to operate as a first node in a communications network (200) for a user device (201) initiating a small data transmission communication session through a receiving node (202) in the communications network (200), and the network node (202) is configured to operate as a receiving node in a communications network (200) for a user device (201) initiating a small data transmission communication session through the receiving node (202),
wherein the network node (202) is configured to:
receive (1001) a request from the user device (201) for the network node (202) to operate as the receiving node for the small data transmission communication session;
send (1002) a request to the first node (203) in the communications network (200) for context information for the user device (201); and
receive (1003) a message from the first node (203) comprising the context information for the user device (201), the context information comprising an indication of small data transmission configuration information (506) for the user device (201);
and wherein the network node (203) is configured to:
receive the request from the receiving node (202); and
send the message to the receiving node (202), the message comprising an indication of small data transmission configuration information (506) for the user device (201).

14. The system as claimed in claim 13, wherein the message is RETRIEVE UE CONTEXT RESPONSE message.

15. The system as claimed in claim 13, wherein the message comprises user equipment, UE, context information, and the UE context information comprises the indication of small data transmission configuration information (506) for the user device (201).

16. The system as claimed in claim 15, wherein the UE context information comprises an access stratum configuration (AS-Config) field (504) and an access stratum context (AS-Context) field (505), the AS-Config field (504) comprises the indication of small data transmission configuration information (506) for the user device (201).

17. The system as claimed in claim 13, wherein the first node (203) is a last serving node that maintains small data transmission configuration information for the user device (201) in the communications network (200).

18. The system as claimed in claim 13, wherein the network node (202) is configured to operate as a receiving node for the user device (201) after relocating the context information for the user device from the first node (203) to the network node (202).

19. The system as claimed in claim 13, wherein the request from the receiving node (202) is part of an XnAP Retrieve UE Context procedure.
